(19) United States
(12) Patent Application Publication
(10) Pub. No.: US 2026/0321705 A1
(43) Pub. Date: Oct. 15, 2026

(54) ALL-SOLID-STATE RECHARGEABLE BATTERY

(71) Applicant: SAMSUNG SDI CO., LTD., Yongin-si, Gyeonggi-do (KR)

(72) Inventors: Dongwoo KIM, Yongin-si, Gyeonggi-do (KR); Hyeoksoo HONG, Yongin-si, Gyeonggi-do (KR); Seongseop KIM, Yongin-si, Gyeonggi-do (KR); Wookjin LEE, Yongin-si, Gyeonggi-do (KR); Seok Joon YOON, Yongin-si, Gyeonggi-do (KR)

(21) Appl. No.: 18/880,451

(22) PCT Filed: Mar. 28, 2024
(86) PCT No.: PCT/KR2024/003899

§ 371 Date: Dec. 31, 2024

(30) Foreign Application Priority Data
Dec. 22, 2023 (KR) 10-2023-0190215

(51) Int. Cl. H01M 10/04

(52) U.S. Cl. CPC H01M 10/0481

(57) ABSTRACT

An all-solid-state rechargeable battery according to an embodiment includes an all-solid-state cell including a positive electrode, a negative electrode, and a solid electrolyte layer, a support plate supporting both surfaces of the all-solid-state cell, and a uniform pressure-applying member disposed between the all-solid-state cell and the support plate and applying uniform pressure to the all-solid-state cell, wherein the uniform pressure-applying member includes a piezoelectric element layer facing both surfaces of the all-solid-state cell and generating a piezoelectric current by the irregular pressure due to the surface irregularities of the all-solid-state cell, and a pressure compensation layer disposed on one surface of the piezoelectric element layer and compensating for the irregular pressure using the piezoelectric current.

### TECHNICAL FIELD

The present disclosure relates to an all-solid-state rechargeable battery.

### BACKGROUND ART

Recent reports of explosion risks in batteries using liquid electrolytes have led to development of all-solid-state rechargeable batteries. An all-solid-state rechargeable battery is a battery in which all materials are solid and uses a solid electrolyte. The all-solid-state rechargeable battery has advantages in that the battery is safe because there is no risk of explosion due to leakage of an electrolyte solution, and the battery is easy to manufacture as a thin battery.

The above-disclosed information is only to enhance understanding of the background of the described technology, and therefore it may contain information that does not constitute the prior art.

### DISCLOSURE

### Technical Problem

The embodiments attempt to provide an all-solid-state rechargeable battery capable of improving the performance of the all-solid-state rechargeable battery by uniformly pressurizing an all-solid-state cell.

Technical solutions obtainable from the present disclosure are not limited to the above-mentioned technical solutions, and other unmentioned technical solutions could be clearly understood from the following description by those having ordinary skill in the technical field to which the present disclosure pertains.

### Technical Solution

An all-solid-state rechargeable battery according to an embodiment for solving the above technical object includes an all-solid-state cell including a positive electrode, a negative electrode, and a solid electrolyte layer, a support plate supporting both surfaces of the all-solid-state cell, and a uniform pressure-applying member disposed between the all-solid-state cell and the support plate and applying a uniform pressure to the all-solid-state cell, wherein the uniform pressure-applying member includes a piezoelectric element layer facing both surfaces of the all-solid-state cell and generating a piezoelectric current by an irregular pressure due to the surface irregularities of the all-solid-state cell, and a pressure compensation layer disposed on one surface of the piezoelectric element layer and compensating for the irregular pressure using the piezoelectric current.

The pressure compensation layer may include a heat shrink layer in contact with one surface of the piezoelectric element layer and including a heat shrink material, and a resistive element disposed on the heat shrink layer and electrically connected to the piezoelectric element to generate resistive heat by the piezoelectric current, and a portion of the heat shrink layer may be contracted by the resistive heat to compensate for the irregular pressure.

The heat shrink layer may include any one heat shrink material selected from polyolefin, fluoropolymer, bismuth-nickel-iron oxide (BiNi1-xFexO3), and bismuth-lanthanum-nickel oxide (Bi0.95La0.05NiO3).

The piezoelectric element layer may be disposed between the heat shrink layer and the all-solid-state cell.

The piezoelectric element layer may include an inelastic layer including an inelastic material, and a plurality of piezoelectric elements disposed on the inelastic layer.

The inelastic layer may be in contact with both surfaces of the all-solid-state cell.

The inelastic layer may surround the plurality of piezoelectric elements.

The inelastic layer may include any one inelastic material selected from inelastic rubber, inelastic clay, plastic, and ceramic.

The inelastic layer may further include any one insulating material selected from glass, ceramic, plastic, urea foam, foam rubber insulation, and rigid urethane.

### Advantageous Effects

According to embodiments, by installing a uniform pressure-applying member including a piezoelectric element layer and a pressure compensation layer, it is possible to finely control even a local pressure increase due to surface irregularities of an all-solid-state cell, thereby applying a uniform pressure to the all-solid-state cell. Therefore, it is possible to improve the performance of the all-solid-state rechargeable battery.

In addition, since uniform pressure may be applied to parts where it is difficult to apply uniform pressure, such as parts adjacent to electrode tabs of the all-solid-state rechargeable battery, the performance of the all-solid-state rechargeable battery may be improved.

In addition, since the uniform pressure-applying member is installed inside the all-solid-state rechargeable battery, it is possible to continuously apply uniform pressure to the all-solid-state cell in the lifespan of the all-solid-state rechargeable battery, thereby improving the lifespan of the all-solid-state rechargeable battery.

### DESCRIPTION OF THE DRAWINGS

While the accompanying drawings illustrate preferred embodiments of the present disclosure and, together with the foregoing disclosure, serve to provide further understanding of the technical spirit of the present disclosure, the present disclosure is not to be construed as being limited to the drawings.

FIG. 1 is a cross-sectional view of an all-solid-state rechargeable battery.

FIG. 2 is a cross-sectional view of an all-solid-state rechargeable battery including a precipitation-type negative electrode.

FIG. 3 is a cross-sectional view of an all-solid-state rechargeable battery according to an embodiment.

FIG. 4 is an enlarged view of a part of FIG. 3.

FIGS. 5 to 7 sequentially illustrate the principle of applying uniform pressure to an all-solid-state cell of an all-solid-state rechargeable battery according to an embodiment.

### MODE FOR INVENTION

The present disclosure will be described in detail hereinafter with reference to the accompanying drawings, in which embodiments of the present disclosure are shown. As those skilled in the art would realize, the described embodiments may be modified in various different ways, all without departing from the spirit or scope of the present invention.

Unless explicitly stated to the contrary, the word “comprise” and variations such as “comprises” and “comprising” should be understood to imply the inclusion of stated elements but not the exclusion of any other elements.

In the drawings, the thicknesses of layers and regions are exaggerated for clarity, and like reference numerals designate like elements throughout the specification. It should be understood that when an element such as a layer, film, region, or substrate is referred to as being “on” another element, it may be directly on the other element or intervening elements may also be present. In contrast, when an element is referred to as being “directly on” another element, there are no intervening elements present.

The term “layer” here includes a construction having a shape formed on a part of a region, in addition to a construction having a shape formed on an entire region. Here, “or” is not interpreted in an exclusive sense—for example, “A or B” is interpreted as including A, B, A+B, or the like.

Positive Electrode for all-Solid-State Rechargeable Battery

In an embodiment, a positive electrode for an all-solid-state rechargeable battery including a current collecting layer and a positive electrode active material layer disposed on the current collecting layer is provided, wherein the positive electrode active material layer includes at least one of a positive electrode active material, a sulfide-based solid electrolyte, a binder, and a conductive material. However, it is not limited thereto, and the positive electrode for the all-solid-state rechargeable battery may include more or less components than the components described above.

In an embodiment, the positive electrode for the all-solid-state rechargeable battery is prepared by applying a positive electrode composition including at least one of a positive electrode active material, a sulfide-based solid electrolyte, a binder, and a conductive material to a current collecting layer, and then drying and rolling.

### Positive Electrode Active Material

The positive electrode active material may be applied without limitation as long as it is generally used in all-solid-state rechargeable batteries. For example, the positive electrode active material may be a compound capable of reversible intercalation and deintercalation of lithium, and may include a compound represented by any of the following chemical formulas:

LiₐA_{1-b}X_{b}DD₂(0.90≤a≤1.8,0≤b≤0.5);

LiₐA_{1-b}X_{b}O_{2-c}D_{c}(0.90≤a≤1.8,0≤b≤0.5,0≤c≤0.05);

LiₐE_{1-b}X_{b}O_{2-c}D_{c}(0.90≤a≤1.8,0≤b≤0.5,0≤c≤0.05);

LiₐE_{2-b}X_{b}O_{4-c}D_{c}(0.90≤a≤1.8,0≤b≤0.5,0≤c≤0.05);

LiₐN_{1-b-c}Co_{b}X_{c}D_{α}(0.90≤a≤1.8,0≤b≤0.5,0≤c≤0.5,0<α≤2);

LiₐNi_{1-b-c}CO_{b}X_{c}O_{2-α}Tα(0.90≤a≤1.8,0≤b≤0.5,0≤c≤0.05,0<α<2);

LiₐNi_{1-b-c}CO_{b}X_{c}O_{2-α}T₂(0.90≤a≤1.8,0≤b≤0.5,0≤c≤0.05,0<α≤2);

LiₐNi_{1-b-c}Mn_{b}X_{c}D_{α}(0.90≤a≤1.8, 0≤b>0.5, 0≤c≤0.05, 0<α≤2);

LiₐNi_{1-b-c}Mn_{b}X_{c}O_{2-α}T_{α}(0.90≤a≤1.8,0≤b≤0.5,0≤c≤0.05,0<α<2);

LiₐNi_{1-b-c}Mn_{b}X_{c}O_{2-α}T_{α}(0.90≤a≤1.8,0≤b≤0.5,0≤c≤0.05,0<α<2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}G_{b}O₂(0.90≤a≤1.8,0.001≤b≤0.1);

LiₐMn₂G_{b}O₄(0.90≤a≤1.8,0.001≤b≤0.1);

LiₐMn_{1-g}G_{g}PO₄(0.90≤a≤1.8,0≤g≤0.5);

QO₂;QS₂;LiQS₂;

V₂O₅;LiV₂O₅;

LiZO₂;

LiNiVO₄;

Li_{(3-f)}J₂PO₄₃(0≤f≤2);

Li_{(3-f)}Fe₂PO₄₃(0≤f≤2);

LiₐFePO₄(0.90≤a≤1.8).

In the above chemical formulas, A is selected from a group consisting of Ni, Co, Mn, and combinations thereof; X is selected from a group consisting of Al, Ni, Co, Mn, Cr, Fe, Mg, Sr, V, a rare earth element, and a combination thereof; D is selected from a group consisting of O, F, S, P, and a combination thereof; E is selected from a group consisting of Co, Mn, and a combination thereof; T is selected from a group consisting of F, S, P, and a combination thereof; G is selected from a group consisting of Al, Cr, Mn, Fe, Mg, La, Ce, Sr, V, and a combination thereof; Q is selected from a group consisting of Ti, Mo, Mn, and a combination thereof; Z is selected from a group consisting of Cr, V, Fe, Sc, Y, and a combination thereof; and J is selected from a group consisting of V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate (LFP).

The positive electrode active material may include a lithium nickel-based oxide represented by Chemical Formula 1 below, a lithium cobalt-based oxide represented by Chemical Formula 2 below, a lithium iron phosphate-based compound represented by Chemical Formula 3 below, or a combination thereof.

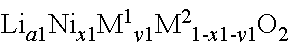

In Chemical Formula 1, 0.9≤a1≤1.8, 0.3≤x1≤1, 0≤y1≤0.7, and M¹ and M² are each independently one or more elements selected from a group consisting of Al, B, Ba, Ca, Ce, Co, Cr, Cu, F, Fe, Mg, Mn, Mo, Nb, P, S, Si, Sr, Ti, V, W, and Zr.

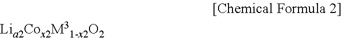

In Chemical Formula 2, 0.9≤a2≤1.8, 0.6≤x2≤1, and M³ is one or more elements selected from the group consisting of Al, B, Ba, Ca, Ce, Cr, Cu, F, Fe, Mg, Mn, Mo, Nb, P, S, Si, Sr, Ti, V, W, and Zr.

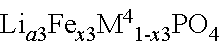

In Chemical Formula 3, 0.9≤a3≤1.8, 0.6≤x3≤1, and M⁴ is one or more elements selected from a group consisting of Al, B, Ba, Ca, Ce, Co, Cr, Cu, F, Fe, Mg, Mn, Mo, Nb, P, S, Si, Sr, Ti, V, W, and Zr.

The average particle diameter (D50) of the positive electrode active material may be 1 μm to 25 μm—for example, 3 μm to 25 μm, 5 μm to 25 μm, 5 μm to 20 μm, 8 μm to 20 μm, or 10 μm to 18 μm. The positive electrode active material having this particle diameter range may be harmoniously mixed with other components within the positive electrode active material layer and may achieve high capacity and high energy density.

The positive electrode active material may be in the form of rechargeable particles made by agglomerating a plurality of primary particles, or may be in the form of single particles. Additionally, the positive electrode active material may be spherical or close to a spherical shape, or may be polyhedral or amorphous.

### Sulfide-Based Solid Electrolyte

The sulfide-based solid electrolyte may include, for example, Li₂S—P₂S₅, Li₂S—P₂S₅—LiX (where X is a halogen element—for example I or Cl), Li₂S—P₂S₅—Li₂O, Li₂S—P₂S₅—Li₂O-Lil, Li₂S—SiS₂, Li₂S—SiS₂-Lil, Li₂S—SiS₂—LiBr, Li₂S—SiS₂—LiCl, Li₂S—SiS₂—B₂S₃-Lil, Li₂S—SiS₂—P₂S₅-Lil, Li₂S—B₂S₃, Li₂S—P₂S₅-ZmSn (where m, n are each an integer, and Z is Ge, Zn or Ga), Li₂S—GeS₂, Li₂S—SiS₂—Li₃PO₄, Li₂S—SiS₂-LiₚMO_{q} (where p and q are integers, and M is P, Si, Ge, B, Al, Ga or In), or a combination thereof.

The sulfide-based solid electrolyte may be obtained, for example, by mixing Li₂S and P₂S₅ at a molar ratio of 50:50 to 90:10, or 50:50 to 80:20, and optionally heat-treating the mixture. Within the above mixing ratio range, a sulfide-based solid electrolyte having excellent ionic conductivity may be prepared. Ion conductivity may be further improved by adding SiS₂, GeS₂, B₂S₃, or the like, as other components.

Mechanical milling or a solution method may be applied as a method of mixing sulfur-containing raw materials to prepare a sulfide-based solid electrolyte. Mechanical milling is a method of mixing starting materials into fine particles by placing the starting materials and a ball mill in a reactor and stirring strongly. When using the solution method, a solid electrolyte may be obtained as a precipitate by mixing the starting materials in a solvent. In addition, when heat treatment is performed after mixing, the crystals of the solid electrolyte may become stronger and ionic conductivity may be improved. For example, a sulfide-based solid electrolyte may be prepared by mixing sulfur-containing raw materials and heat-treating them two or more times, and in this case, a sulfide-based solid electrolyte with high ionic conductivity and robustness may be prepared.

For example, the sulfide-based solid electrolyte particles may include argyrodite-type sulfide. The argyrodite-type sulfide may be represented by, for example, a chemical formula LiₐM_{b}P_{c}S_{d}Aₑ (where a, b, c, d, and e are all 0 or more and 12 or less, M is a metal other than Li or a combination of a plurality of metals other than Li, and A is F, Cl, Br, or I), and as a specific example, the argyrodite-type sulfide may be represented by a chemical formula of Li₇₋ₓPS₆₋ₓAₓ (where x is 0.2 or more and 1.8 or less, and A is F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide-based solid electrolyte particle including the argyrodite-type sulfide have a high ionic conductivity close to the range of 10⁻⁴ to 10⁻² S/cm, which is the ionic conductivity of a typical liquid electrolyte at room temperature, and may form a tight bond between the positive electrode active material and the solid electrolyte without causing a decrease in ionic conductivity, and further, may form a tight interface between the electrode layer and the solid electrolyte layer. All-solid-state batteries including argyrodite-type sulfide may have improved battery performance such as rate characteristics, Coulombic efficiency, and lifespan characteristics.

The argyrodite-type sulfide-based solid electrolyte may be prepared, for example, by mixing lithium sulfide, phosphorus sulfide, and selectively lithium halide. After mixing them, heat treatment may be performed. The heat treatment may include, for example, two or more heat treatment steps.

The average particle diameter (D50) of the sulfide-based solid electrolyte particles according to an embodiment may be 5.0 μm or less—for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particles may be small particles having an average particle diameter (D50) of 0.1 μm to 1.0 μm depending on the position or purpose of use, or large particles having an average particle diameter (D50) of 1.5 μm to 5.0 μm. Sulfide-based solid electrolyte particles in this particle diameter range may effectively penetrate between solid particles in a battery, and have excellent contact with the electrode active material and connectivity between solid electrolyte particles. The average particle diameter of the sulfide-based solid electrolyte particles may be measured from a microscope image—for example, by measuring the size of about 20 particles from a scanning electron microscope image to obtain a particle size distribution—and then calculating the D50 therefrom.

The amount of the solid electrolyte in the positive electrode for an all-solid-state battery may be 0.5 wt % to 35 wt %—for example, 1 wt % to 35 wt %, 5 wt % to 30 wt %, 8 wt % to 25 wt %, or 10 wt % to 20 wt %. This is the amount relative to the total weight of the components in the positive electrode, and specifically, it can be said to be the amount relative to the total weight of the positive electrode active material layer.

In an embodiment, the positive electrode active material layer may include a positive electrode active material of 50 wt % to 99.35 wt % based on 100 wt % of the positive electrode active material layer, a sulfide-based solid electrolyte of 0.5 wt % to 35 wt %, a fluorinated resin binder of 0.1 wt % to 10 wt %, and a vanadium oxide of 0.05 wt % to 5 wt %. If this amount range is satisfied, the positive electrode for an all-solid-state rechargeable battery maintains high adhesion while maintaining high capacity and high ionic conductivity, and the viscosity of the positive electrode composition is maintained at an appropriate level, thereby improving processability.

### Binder

The binder improves binding properties of positive active material particles with one another and with a current collector, and examples of the binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

### Conductive Material

The positive electrode active material may further include a conductive material. The conductive material is used to provide conductivity to an electrode, and may include, for example, a carbon-based material such as natural graphite, artificial graphite, carbon black, acetylene black, Ketjenblack, a carbon fiber, a carbon nanotube, or the like; a metal-based material of a metal powder or a metal fiber including copper, nickel, aluminum, silver, or the like; a conductive polymer such as a polyphenylene derivative; or a combination thereof.

The conductive material may be included in an amount of 0.1 wt % to 5 wt %, or 0.1 wt % to 3 wt %, based on the total weight of each component of the positive electrode for an all-solid-state battery, or based on the total weight of the positive electrode active material layer. Within the above amount range, the conductive material may improve electrical conductivity without degrading battery performance.

If the positive electrode active material layer further includes a conductive material, the positive electrode active material layer may include 45 wt % to 99.25 wt % of the positive electrode active material, 0.5 wt % to 35 wt % of a sulfide-based solid electrolyte, 0.1 wt % to 10 wt % of a fluorinated resin binder, 0.05 wt % to 5 wt % of vanadium oxide, and 0.1 wt % to 5 wt % of a conductive material, based on 100 wt % of the positive electrode active material layer.

Meanwhile, the positive electrode for a lithium rechargeable battery may further include an oxide-based inorganic solid electrolyte in addition to the solid electrolyte described above. The oxide-based inorganic solid electrolyte may include, for example, Li₁₊ₓTi₂₋ₓAl PO₄₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y} TiyO₃(PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSiyP_{3-y}O₁₂ (0≤x≤1, 0≤y≤1), lithium lanthanum titanate (LixLayTiO₃, 0<x<2, 0<y<3), Li₂O, LiAlO₂, Li₂O—Al₂O₃—SiO₂—P₂O₅ —TiO₂-GₑO₂ ceramics, garnet ceramics (Li₃₊ₓLa₃M₂O₁₂(M=Te, Nb, or Zr; where x is an integer 1 to 10), or a combination thereof.

### All-Solid-State Rechargeable Battery

In an embodiment, an all-solid-state rechargeable battery is provided, which includes the above-described positive electrode and negative electrode, and a solid electrolyte layer disposed between the positive electrode and the negative electrode. The all-solid-state rechargeable battery may be represented by an all-solid-state battery or an all-solid-state lithium rechargeable battery.

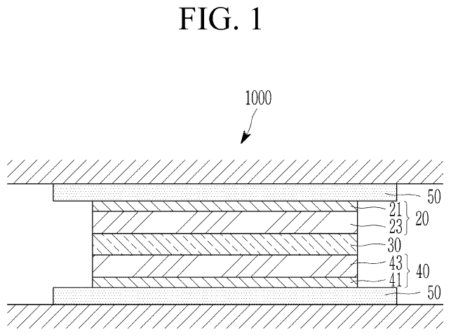

FIG. 1 is a cross-sectional view of an all-solid-state battery.

Referring to FIG. 1, an all-solid-state battery 1000 may be a structure in which an electrode assembly is stacked, having a negative electrode 40 including a negative electrode current collecting layer 401 and a negative electrode active material layer 43, a solid electrolyte layer 30, and a positive electrode 20 including a positive electrode active material layer 23 and a positive electrode current collecting layer 21, and is accommodated in a case, such as a pouch. The all-solid-state battery 1000 may further include an elastic layer 50 on the outside of at least one of the positive electrode 20 and the negative electrode 40. Although FIG. 1 shows one electrode assembly including the negative electrode 40, the solid electrolyte layer 30, and the positive electrode 20, an all-solid-state battery may also be prepared by stacking two or more electrode assemblies.

### Negative Electrode

For example, a negative electrode for an all-solid-state battery may include a current collector and a negative electrode active material layer positioned on the current collector. The negative electrode active material layer may include a negative electrode active material and may further include a binder, a conductive material, and/or a solid electrolyte.

The negative electrode active material may include a material capable of reversible intercalation/deintercalation of lithium ion, lithium metal, an alloy of lithium metal, a material capable of doping and dedoping lithium, or a transition metal oxide.

The material capable of reversibly intercalating/deintercalating lithium ions is a carbon-based negative electrode active material, and may include, for example, crystalline carbon, amorphous carbon, or a combination thereof. Examples of the crystalline carbon may be amorphous, sheet, flake, spherical or fiber-shaped natural graphite or artificial graphite. Examples of the amorphous carbon may be a soft carbon or hard carbon, mesophase pitch carbide, fired coke, or the like.

The lithium metal alloy may be lithium and an alloy of metals selected from the group consisting of Na, K, Rb, Cs, Fr, Be, Mg, Ca, Sr, Si, Sb, Pb, In, Zn, Ba, Ra, Ge, Al and Sn.

The material capable of doping and dedoping lithium may be an Si-based negative electrode active material or an Sn-based negative electrode active material, the Si-based negative electrode active material may include silicon, silicon-carbon composite, SiOx (0<x<2), Si-Q alloy (wherein Q is an element selected from the group consisting of alkali metals, alkaline earth metals, a Group 13 element, a Group 14 element, a Group 15 element, a Group 16 element, a transition metal, a rare earth element, and a combination thereof, but not Si), and the Sn-based negative electrode active materials include Sn, SnO₂, and Sn—R alloy (where R is an alkali metal, an alkaline-earth metal, a Group 13 element, a Group 14 element, a Group 15 element, a Group 16 element, a transition metal, a rare earth element, and a combination thereof, but not Sn), and the like, and at least one of these materials may be mixed with SiO₂. The elements Q and R may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

For example, the silicon-carbon composite may be a silicon-carbon composite including a core containing crystalline carbon and silicon particles and an amorphous carbon coating layer positioned on the surface of the core. The crystalline carbon may be artificial graphite, natural graphite, or a combination thereof. The amorphous carbon precursor may be coal pitch, mesophase pitch, petroleum pitch, coal-based oil, petroleum-based heavy oil, or polymer resin such as phenol resin, furan resin, and polyimide resin, and the like. At this time, the amount of silicon may be 10 wt % to 50 wt % based on the total weight of the silicon-carbon composite. In addition, the amount of the crystalline carbon may be 10 wt % to 70 wt % based on the total weight of the silicon-carbon composite, and the amount of the amorphous carbon may be 20 wt % to 40 wt % based on the total weight of the silicon-carbon composite. Additionally, the thickness of the amorphous carbon coating layer may be 5 nm to 100 nm.

The average particle diameter (D50) of the silicon particles may be 10 nm to 20 μm—for example, 10 nm to 500 nm. The silicon particles may exist in an oxidized form, and in this case, the atomic amount ratio of Si:O in the silicon particles, which indicates the degree of oxidation, may be 99:1 to 33:67. The silicon particles may be SiOx particles, and in this case, the x range in SiOx may be greater than 0 and less than 2. Here, the average particle diameter (D50) is measured with a particle size analyzer using a laser diffraction method and means the diameter of particles with a cumulative volume of 50% by volume in the particle size distribution.

The Si-based negative electrode active material or Sn-based negative electrode active material may be used by mixing with a carbon-based negative electrode active material. The mixing ratio of Si-based negative electrode active material or Sn-based negative electrode active material and carbon-based negative electrode active material may be 1:99 to 90:10 in weight ratio.

The amount of the negative electrode active material in the negative electrode active material layer may be 95 wt % to 99 wt % based on the total weight of the negative electrode active material layer.

In an embodiment, the negative electrode active material layer further includes a binder and, optionally, may further include a conductive material. The amount of the binder in the negative electrode active material layer may be 1 wt % to 5 wt % based on the total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other and adhere the negative electrode active material to the current collector. The binder may include a non-water-soluble binder, a water-soluble binder, or a combination thereof.

The non-water-soluble binder may include, for example, polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamide-imide, polyimide, or a combination thereof.

The water-soluble binder may be a rubber-based binder or polymer resin binder. The rubber-based binder may be selected from styrene-butadiene rubber, acrylated styrene-butadiene rubber, acrylonitrile-butadiene rubber, acrylic rubber, butyl rubber, fluorine rubber, and a combination thereof. The polymer resin binder may be selected from polyethylene oxide, polyvinylpyrrolidone, polyepichlorohydrin, polyphosphazene, polyacrylonitrile, ethylene propylene diene copolymer, polyvinylpyridine, chlorosulfonated polyethylene, latex, polyester resin, acryl resin, phenol resin, epoxy resin, polyvinyl alcohol, and a combination thereof.

If a water-soluble binder is used as the negative electrode binder, a thickener capable of providing viscosity may be used together, and the thickener may include, for example, a cellulose-based compound. The cellulose-based compound may include carboxymethyl cellulose, hydroxypropyl methyl cellulose, methyl cellulose, alkali metal salts thereof, or a combination thereof. The alkali metals may be Na, K, or Li. The amount of the thickener used may be 0.1 to 3 parts by weight based on 100 parts by weight of the negative electrode active material.

The conductive material is used to provide conductivity to an electrode, and may include, for example, a carbon-based material such as natural graphite, artificial graphite, carbon black, acetylene black, Ketjenblack, a carbon fiber, a carbon nanotube, or the like; a metal-based material of a metal powder or a metal fiber including copper, nickel, aluminum, silver, or the like; a conductive polymer such as a polyphenylene derivative; or a combination thereof.

The negative electrode current collector may be selected from copper foil, nickel foil, stainless steel foil, titanium foil, nickel foam, copper foam, a polymer substrate coated with a conductive metal, and a combination thereof.

As another example, the negative electrode for an all-solid-state battery may be a precipitation-type negative electrode. The precipitation-type negative electrode refers to a negative electrode that does not contain a negative electrode active material during battery assembly, but metals such as lithium are precipitation-type, which serve as the negative electrode active material.

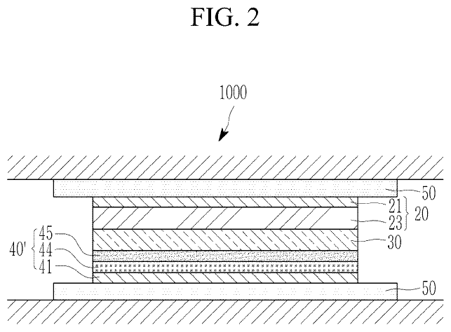

FIG. 2 is a cross-sectional view of an all-solid-state battery including a precipitation-type negative electrode.

Referring to FIG. 2, a precipitation-type negative electrode 40′ may include the current collecting layer 41 and a negative electrode coating layer 45 disposed on the current collecting layer 41. An all-solid-state battery with the precipitation-type negative electrode 40′ begins initial charging in a state where there is no negative electrode active material, and during charging, high-density lithium metal is deposited between the current collecting layer 41 and the negative electrode coating layer 45, forming a lithium metal layer 44, which may serve the role of the negative electrode active material. Accordingly, in an all-solid-state battery that has been charged at least once, the precipitation-type negative electrode 40′ may include the current collecting layer 41, the lithium metal layer 44 disposed on the current collecting layer, and the negative electrode coating layer 45 disposed on the metal layer. The lithium metal layer 44 refers to a layer in which lithium metal, etc. is deposited during the charging process of the battery, and may be referred to as a metal layer or a negative electrode active material layer.

The negative electrode coating layer 45 may include metal, carbon material, or a combination thereof that acts as a catalyst.

The metal may include, for example, gold, platinum, palladium, silicon, silver, aluminum, bismuth, tin, zinc, or a combination thereof, or may include one of these or various types of alloys. If the metal exists in particle form, the average particle diameter (D50) of the metal may be about 4 μm or less—for example, 10 nm to 4 μm.

The carbon material may be, for example, crystalline carbon, amorphous carbon, or a combination thereof. The crystalline carbon may be, for example, natural graphite, artificial graphite, mesophase carbon microbeads, or a combination thereof. The amorphous carbon may be, for example, carbon black, activated carbon, acetylene black, denka black, Ketjenblack, or a combination thereof.

If the negative electrode coating layer 45 includes both the metal and the carbon material, the mixing ratio of the metal and the carbon material may be, for example, a weight ratio of 1:10 to 2:1. In this case, the precipitation of lithium metal may be effectively promoted and the characteristics of the all-solid-state battery may be improved. For example, the negative electrode coating layer 45 may include a carbon material on which a catalyst metal is supported, or may include a mixture of metal particles and carbon material particles.

For example, the negative electrode coating layer 45 may include, for example, metal and amorphous carbon, which can effectively promote precipitation of lithium metal.

The negative electrode coating layer 45 may further include a binder, and the binder may be a conductive binder. Additionally, the negative electrode coating layer 45 may further include general additives such as fillers, dispersants, and ion conductive materials.

The thickness of the negative electrode coating layer 45 may be, for example, 100 nm to 20 μm, or 500 nm to 10 μm, or 1 μm to 5 μm.

For example, the precipitation-type negative electrode 40′ may further include a thin film on the surface of the current collecting layer 41—that is, between the current collecting layer 41 and the negative electrode coating layer 45. The thin film may include an element capable of forming an alloy with lithium. Elements capable of forming an alloy with lithium may be, for example, gold, silver, zinc, tin, indium, silicon, aluminum, bismuth, etc., and may include one type or various types of alloys. The thin film may further planarize the precipitation form of the lithium metal layer 44 and further improve the characteristics of the all-solid-state battery. The thin film may be formed by, for example, vacuum deposition, sputtering, or plating methods. The thickness of the thin film may be, for example, 1 nm to 500 nm.

### Solid Electrolyte Layer

The solid electrolyte layer 30 may include a sulfide-based solid electrolyte, an oxide-based solid electrolyte, or the like. The specific details of the sulfide-based solid electrolyte and the oxide-based solid electrolyte are as described above.

For example, the solid electrolyte included in the positive electrode 20 and the solid electrolyte included in the solid electrolyte layer 30 may include the same compound or different compounds. For example, if both the positive electrode 20 and the solid electrolyte layer 30 include an argyrodite-type sulfide-based solid electrolyte, the overall performance of the all-solid-state rechargeable battery may be improved. In addition, for example, if both the positive electrode 20 and the solid electrolyte layer 30 include the above-described coated solid electrolyte, the all-solid-state rechargeable battery may achieve high capacity and high energy density while exhibiting excellent initial efficiency and lifespan characteristics.

Meanwhile, the average particle diameter (D50) of the solid electrolyte included in the positive electrode 20 may be smaller than the average particle diameter (D50) of the solid electrolyte included in the solid electrolyte layer 30. In this case, overall performance may be improved by maximizing the energy density of the all-solid-state battery and increasing the mobility of lithium ions. For example, the average particle diameter (D50) of the solid electrolyte included in the positive electrode 20 may be 0.1 μm to 1.0 μm, or 0.1 μm to 0.8 μm, and the average particle diameter (D50) of the solid electrolyte included in the solid electrolyte layer 30 may be between 1.5 μm and 5.0 μm, or between 2.0 μm and 4.0 μm, or between 2.5 μm and 3.5 μm. If this particle diameter range is satisfied, the energy density of the all-solid-state rechargeable battery may be maximized while facilitating the transfer of lithium ions, thereby suppressing resistance and thus improving the overall performance of the all-solid-state rechargeable battery. Here, the average particle diameter (D50) of the solid electrolyte may be measured through a particle size analyzer using laser diffraction. Alternatively, the D50 value may be calculated by selecting about 20 particles from a microscope photo such as a scanning electron microscope, measuring the particle size, and obtaining the particle size distribution.

The solid electrolyte layer may further include a binder in addition to the solid electrolyte. At this time, the binder may be styrene butadiene rubber, polytetrafluoroethylene, polyvinylidene fluoride, polyethylene, acrylate polymer, or a combination thereof, but is not limited thereto, and any binder that is used in the related art may be used. The acrylate-based polymer may be, for example, butyl acrylate, polyacrylate, polymethacrylate, or a combination thereof.

The solid electrolyte layer may be formed by adding a solid electrolyte to a binder solution, coating it onto a base film, and drying it. The solvent for the binder solution may be isobutyl isobutyrate, xylene, toluene, benzene, hexane, or a combination thereof. Since the solid electrolyte layer forming process is widely known in the related art, a detailed description will be omitted.

The thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. The content of the lithium salt in the solid electrolyte layer may be greater than or equal to 1M, for example, 1M to 4 M. In this case, the lithium salt may improve ion conductivity by improving the lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, Lil, LiB(C₂O₄)₂, LiBF₄, LiBF₃(C₂F₅), lithium bis(oxalato) borate (LiBOB), lithium oxalyldifluoroborate (LIODFB), lithium difluoro (oxalato) borate (LiDFOB), lithium bis(trifluoro methanesulfonyl)imide, LiTFSI, LiN(SO₂CF₃)₂), lithium bis(fluorosulfonyl)imide, LiN(SO₂F)₂), LiCF₃SO₃, LiAsF₆, LiSbF₆, LiClO₄, or mixtures thereof.

In addition, the lithium salt may be an imide—based lithium salt—for example, the imide-based lithium salt may include lithium bis(trifluoro methanesulfonyl)imide, LiTFSI, LiN(SO₂CF₃)₂), lithium bis(fluorosulfonyl)imide, LIFSI, LiN(SO₂F)₂). The lithium salt may maintain or improve ionic conductivity by maintaining appropriate chemical reactivity with ionic liquid.

The ionic liquid refers to a salt or room-temperature molten salt that has a melting point below room temperature and is therefore liquid at room temperature, including only ions.

The ionic liquid may be a compound including a) one or more positive ions selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and mixtures thereof, and b) one or more negative ions selected from BF₄—, PF₆—, AsF₆—, SbF₆—, AICl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)₂N—.

The ionic liquid may be one or more selected from the group consisting of, for example, N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide and 1-ethyl-3-methylimidazolium bis(trifluoromethylsulfonyl)amide.

The weight ratio of the solid electrolyte and the ionic liquid in the solid electrolyte layer may be 0.1:99.9 to 90:10—for example, 10:90 to 90:10, 20:80 to 90:10, 30:70 to 90:10, 40:60 to 90:10, or 50:50 to 90:10. A solid electrolyte layer that satisfies the above range may maintain or improve ionic conductivity by improving the electrochemical contact area with the electrode. Accordingly, the energy density, discharge capacity, and rate characteristics of the all-solid-state battery may be improved.

The all-solid-state battery may be a unit cell having a structure of positive electrode/solid electrolyte layer/negative electrode, a bi-cell having a structure of positive electrode/solid electrolyte layer/negative electrode/solid electrolyte layer/positive electrode, or a stacked battery in which the structure of the unit cell is repeated.

The shape of the all-solid-state battery is not particularly limited, and may be, for example, coin-shaped, button-shaped, sheet-shaped, stacked-shaped, cylindrical, flat, or the like. Additionally, the all-solid-state battery may be applied to large batteries used in electric vehicles, or the like. For example, the all-solid-state battery may also be used in hybrid vehicles such as plug-in hybrid electric vehicles (PHEV). Additionally, the all-solid-state battery may be used in fields that require large amounts of power storage—for example, electric bicycles or power tools.

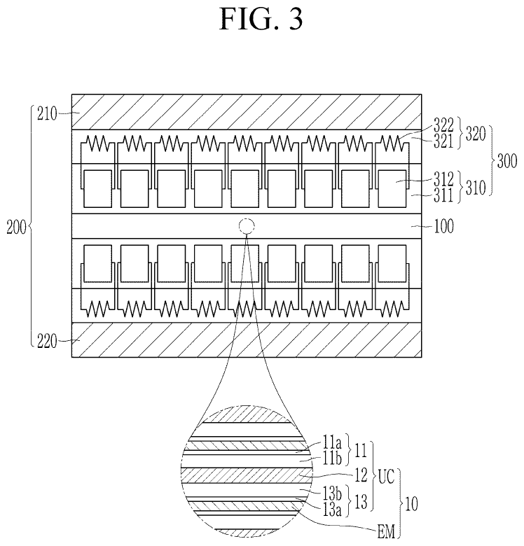

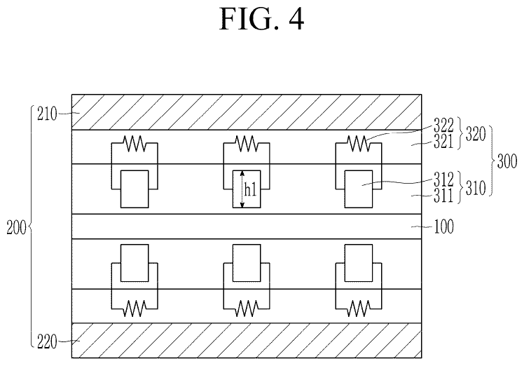

Hereinafter, an all-solid-state rechargeable battery according to an embodiment will be described with reference to FIGS. 3 and 4.

FIG. 3 is a cross-sectional view of an all-solid-state rechargeable battery according to an embodiment, and FIG. 4 is an enlarged view of a part of FIG. 3.

As shown in FIGS. 3 and 4, an all-solid-state rechargeable battery according to an embodiment includes an all-solid-state cell 100, a support plate 200, and a uniform pressure-applying member 300.

The all-solid-state cell 100 may have a stack cell structure in which a plurality of unit cells UC and elastic members EM are stacked.

A single unit cell UC may include a positive electrode 11, a negative electrode 13, and a solid electrolyte layer 12. Here, the positive electrode 11 may include a cathode, and the negative electrode 13 may include an anode.

The positive electrode 11 may include a positive electrode current collecting layer 11a and a positive electrode active material layer 11b disposed on one surface of the positive electrode current collecting layer 11a. The positive electrode current collecting layer 11a may include any one selected from aluminum (Al), indium (In), copper (Cu), magnesium (Mg), stainless steel (SUS), titanium (Ti), iron (Fe), cobalt (Co), nickel (Ni), zinc (Zn), germanium (Ge), and lithium (Li). The positive electrode active material layer 11b may include any one selected from lithium salts such as nickel cobalt manganese oxide (NCM), lithium cobalt oxide (LCO), lithium nickel oxide, lithium nickel cobalt oxide, lithium nickel cobalt aluminum oxide (NCA), lithium manganate, lithium iron phosphate, nickel sulfide, copper sulfide, lithium sulfur, iron oxide, or vanadium oxide.

The negative electrode 13 may include a negative electrode current collecting layer 13a and a negative electrode coating layer 13b disposed on one surface of the negative electrode current collecting layer 13a. The negative electrode current collecting layer 13a may have a plate shape or a foil shape. The negative electrode current collecting layer 13a may include various known metals and compounds that do not react with lithium. The positive electrode current collecting layer 13a may include any one selected from stainless steel (SUS), copper (Cu), titanium (Ti), iron (Fe), cobalt (Co), and nickel (Ni). The negative electrode coating layer 13b may include silver (Ag) and carbon (C), but is not limited thereto. For example, the negative electrode coating layer 13b may have a structure in which particles formed of a metal or semiconductor including at least one of gold (Au), platinum (Pt), palladium (Pd), silicon (Si), silver (Ag), aluminum (AI), bismuth (Bi), tin (Sn), and zinc (Zn) are contained in a carbon layer including at least one of carbon black (CB), furnace black (FB), acetylene black (AB), Ketjenblack (KB), and graphene. When charging an all-solid-state rechargeable battery, lithium (Li) is deposited between the negative electrode current collecting layer 13a and the negative electrode coating layer 13b, and a lithium metal layer is formed between the negative electrode current collecting layer 13a and the negative electrode coating layer 13b, and after discharging the all-solid-state rechargeable battery, the lithium deposited between the negative electrode current collecting layer 13a and the negative electrode coating layer 13b is removed, so that the negative electrode current collecting layer 13a and the negative electrode coating layer 13b may be in direct contact.

The solid electrolyte layer 12 may be disposed between the positive electrode active material layer 11b and the negative electrode coating layer 13b. The solid electrolyte layer 12 may include, but is not limited to, various known sulfide-based solid electrolyte materials. For example, the solid electrolyte layer 12 may include Li₂S—P₂S₅, Li₂S—P₂S₅—LiX (X is a halogen element—for example, I or CI), Li₂S—P₂S₅—Li₂O, Li₂S—P₂S₅—Li₂O-Lil, Li₂S—SiS₂, Li₂S—SiS₂-Lil, Li₂S—SiS₂—LiBr, Li₂S—SiS₂—LiCl, Li₂S—SiS₂—B₂S₃-Lil, Li₂S—SiS₂—P₂S₅-Lil, Li₂S—B₂S₃, Li₂S—P₂S₅-ZmSn (m and n are positive numbers, and Z is one of Ge, Zn, or Ga), Li₂S—GeS₂, Li₂S—SiS₂—Li₃PO₄, Li₂S—SiS₂-LiₚMO_{q} (p and q are positive numbers, M is one of P, Si, Ge, B, Al, Ga, and In). The solid electrolyte layer 12 may include at least one of an amorphous material and a crystalline material.

The elastic member EM may include an elastic material such as rubber, elastomer, or foam.

In order for lithium (Li) to grow and be reduced uniformly during charging and discharging of an all-solid-state rechargeable battery, a uniform pressure must be applied to the entire area of the all-solid-state rechargeable battery. To this end, the elastic member EM is installed between adjacent unit cells UC to provide elastic force to the unit cells UC, thereby allowing a constant pressure to be applied to the unit cells UC.

The support plate 200 may support and pressurize both surfaces of the all-solid-state cell 100.

The support plate 200 may include an upper support plate 210 and a lower support plate 220 that are spaced apart from each other. The upper support plate 210 and the lower support plate 220 have the same size and may face each other at a predetermined distance apart from each other. The upper support plate 100 and the lower support plate 200 may each face both surfaces of the all-solid-state cell 100 and pressurize both surfaces of the all-solid-state cell 100.

The uniform pressure-applying member 300 may be disposed between the all-solid-state cell 100 and the support plate 200, and may apply a uniform pressure to the all-solid-state cell 100.

The uniform pressure-applying member 300 may include a piezoelectric element layer 310 and a pressure compensation layer 320.

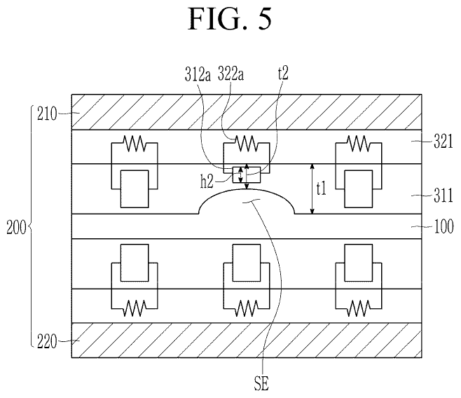

The piezoelectric element layer 310 may face both surfaces of the all-solid-state cell 100. When charging and discharging an all-solid-state rechargeable battery, surface irregularities (SE, see FIG. 5) may occur locally in the all-solid-state cell 100 due to side reaction. These local surface irregularities SE cause a local increase in volume, resulting in an irregular pressure. The irregular pressure may cause uneven pressure to be applied to the all-solid-state cell.

However, in the present embodiment, the piezoelectric element layer 310 may generate a piezoelectric current I by utilizing this irregular pressure.

The piezoelectric element layer 310 may include an inelastic layer 311 and a plurality of piezoelectric elements 312.

The inelastic layer 311 may include an inelastic material that does not return to its original shape after deformation. The inelastic material does not have a standard elasticity modulus and does not follow Hooke's law, which is the basis for defining the elasticity modulus (Young's modulus). The inelastic layer 311 may include an inelastic material such as inelastic rubber, inelastic clay, plastic, or ceramic.

The inelastic layer 311 may be in direct contact with both surfaces of the all-solid-state cell 100.

A plurality of piezoelectric elements 312 may be disposed onside the inelastic layer 311. The piezoelectric element may be surrounded by the inelastic layer 311.

If the piezoelectric element 312 is disposed onside the elastic layer, the piezoelectric current I is continuously generated in the piezoelectric element 312 by the force of the elastic layer pulling the deformed piezoelectric element 312 to both sides. Accordingly, there is a problem in that resistive heat is continuously generated in the pressure compensation layer 320 connected to the piezoelectric element 312.

However, as in the present embodiment, when the piezoelectric element 312 is disposed on the inelastic layer 311, the inelastic layer 311 does not apply pressure to the deformed piezoelectric element 312, so unnecessary resistive heat may be prevented from being generated in the pressure compensation layer 320 connected to the piezoelectric element 312.

The pressure compensation layer 320 may be disposed on one surface of the piezoelectric element layer 310. That is, the pressure compensation layer 320 may be disposed on the piezoelectric element layer 310, which is disposed on the conductor cell 100, and under the piezoelectric element layer 310, which is disposed under the conductor cell 100. The pressure compensation layer 320 may compensate for the irregular pressure by using the piezoelectric current I generated in the piezoelectric element layer 310.

The pressure compensation layer 320 may include a heat shrink layer 321 and a resistive element 322.

The heat shrink layer 321 may be in contact with one surface of the piezoelectric element layer 310 and may include a heat shrink material. The heat shrink material is a material that has the property of shrinking when exposed to heat.

The heat shrink layer 321 may include a heat shrink material such as polyolefin, fluoropolymer, bismuth-nickel-iron oxide (BiNi1-xFexO3), or bismuth-lanthanum nickel oxide (Bi0.95La0.05NiO3).

The resistive element 322 is disposed on the heat shrink layer 321 and may be electrically connected to the piezoelectric element 312 to generate resistive heat by the piezoelectric current I generated from the piezoelectric element 312.

A portion of the heat shrink layer 321 may shrink due to the resistive heat to compensate for the irregular pressure.

Hereinafter, the principle of applying uniform pressure to the all-solid-state cell of the all-solid-state rechargeable battery according to the present embodiment is described in detail with reference to the drawings.

FIGS. 5 to 7 sequentially illustrate the principle of applying uniform pressure to an all-solid-state cell of an all-solid-state rechargeable battery according to an embodiment.

First, as shown in FIG. 5, when the surface irregularities SE occur locally in the all-solid-state cell 100, the volume locally increases due to the local surface irregularities SE caused by the local side reaction of the all-solid-state cell 100, thereby generating irregular pressure in the adjacent piezoelectric element layer 310. Accordingly, the thickness of the inelastic layer 311 at a position corresponding to the surface irregularities SE decreases from t1 to t2, and the thickness of a piezoelectric element 312a at a position corresponding to the surface irregularities SE also decreases from h1 to h2. Accordingly, the piezoelectric element 312a contracts and the piezoelectric current I is generated. Resistive heat is then generated in a resistive element 322a by the piezoelectric current I.

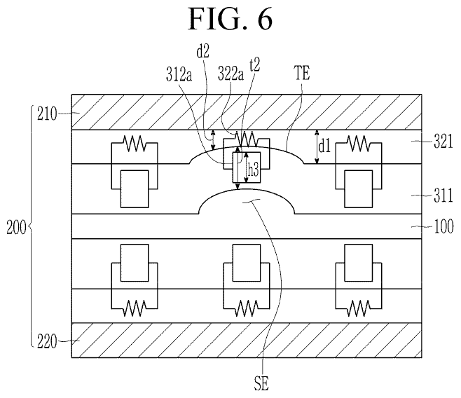

Next, as shown in FIG. 6, the thickness of the heat shrink layer 321 is reduced from d1 to d2 due to the resistive heat generated in the resistive element 322. At this time, as the thickness of the heat shrink layer 321 decreases, the thickness of the inelastic layer 311 increases, so that a boundary surface TE of the inelastic layer 311 and the heat shrink layer 321 may be convexly deformed into the same shape as the surface irregularities SE. Accordingly, the irregular pressure applied to the piezoelectric element layer 310 at a position corresponding to the surface irregularities SE is reduced. Accordingly, the thickness of the piezoelectric element 312a increases from h2 to h3. Furthermore, as the thickness of the piezoelectric element 312a is restored, the amount of piezoelectric current I generated decreases, and the resistive heat generated in the resistive element 322a also decreases, resulting in a decrease in the shrinkage rate of the heat shrink layer 321.

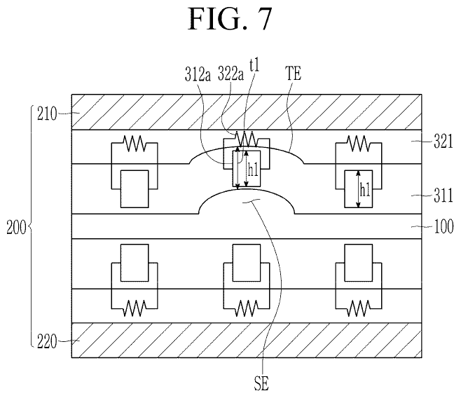

Next, as shown in FIG. 7, as the thickness of the piezoelectric element 312a is restored to the original thickness h1, the piezoelectric current I is not generated and resistive heat is not generated in the resistive element 322a. Also, since the thickness of the inelastic layer 311 at the position corresponding to the surface irregularities SE is almost restored from t2 to t1, the irregular pressure due to the surface irregularities SE is reduced.

As such, in the present embodiment, by installing the uniform pressure-applying member 300 including the piezoelectric element layer 310 and the pressure compensation layer 320, it is possible to finely control even the local pressure increase due to the surface irregularities SE of the all-solid-state cell 100, thereby applying a uniform pressure to the all-solid-state cell 100. Therefore, it is possible to improve the performance of the all-solid-state rechargeable battery.

In addition, since uniform pressure may be applied to parts where it is difficult to apply uniform pressure, such as parts adjacent to the electrode tabs of an all-solid-state rechargeable battery, the performance of the all-solid-state rechargeable battery may be improved.

In addition, since the uniform pressure-applying member is installed inside the all-solid-state rechargeable battery, it is possible to continuously apply uniform pressure to the all-solid-state cell in the lifespan of the all-solid-state rechargeable battery, thereby improving the lifespan of the all-solid-state rechargeable battery.

Meanwhile, the inelastic layer 311 may further include an insulating material. The insulating material may include glass, ceramic, plastic, urea foam, foam rubber insulation, rigid urethane, etc. The insulating material is flame retardant below 100 degrees and may have a thermal conductivity of about 0.02 W/mk.

If the heat shrink layer 321 is unintentionally contracted due to heat generation from the all-solid-state cell and remains in a permanently contracted state, the overall pressure applied to the all-solid-state cell may be reduced, thereby reducing the performance of the all-solid-state rechargeable battery.

Thus, by positioning the piezoelectric element layer 310 between the heat shrink layer 321 and the all-solid-state cell 100, it is possible to prevent the heat shrink layer 321 from being unintentionally contracted due to heat generated from the all-solid-state cell 100.

In addition, since the non-elastic layer 311 in contact with the all-solid-state cell 100 further includes an insulating material, heat generated in the all-solid-state cell 100 is prevented from being transferred to the heat shrink layer 321, thereby preventing the heat shrink layer 321 from being unintentionally contracted due to heat generated in the all-solid-state cell 100.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

1. An all-solid-state rechargeable battery, comprising:
an all-solid-state cell including a positive electrode, a negative electrode, and a solid electrolyte layer;
a support plate supporting both surfaces of the all-solid-state cell; and
a uniform pressure-applying member disposed between the all-solid-state cell and the support plate and applying uniform pressure to the all-solid-state cell,
wherein the uniform pressure-applying member comprises:
a piezoelectric element layer facing both surfaces of the all-solid-state cell and generating a piezoelectric current by the irregular pressure due to the surface irregularities of the all-solid-state cell; and
a pressure compensation layer disposed on one surface of the piezoelectric element layer and compensating for the irregular pressure using the piezoelectric current.

2. The all-solid-state rechargeable battery as claimed in claim 1, wherein
the pressure compensation layer comprises:
a heat shrink layer in contact with one surface of the piezoelectric element layer and including a heat shrink material; and
a resistive element disposed on the heat shrink layer and electrically connected to the piezoelectric element to generate resistive heat by the piezoelectric current,
and a portion of the heat shrink layer is contracted by the resistive heat to compensate for the irregular pressure.

3. The all-solid-state rechargeable battery as claimed in claim 2, wherein
the heat shrink layer comprises any one heat shrink material selected from polyolefin, fluoropolymer, bismuth-nickel-iron oxide (BiNi1-xFexO3), and bismuth-lanthanum nickel oxide (Bi0.95La0.05NiO3).

4. The all-solid-state rechargeable battery as claimed in claim 2, wherein
the piezoelectric element layer is disposed between the heat shrink layer and the all-solid-state cell.

5. The all-solid-state rechargeable battery as claimed in claim 1, wherein
the piezoelectric element layer comprises:
an inelastic layer including an inelastic material; and
a plurality of piezoelectric elements disposed on the inelastic layer.

6. The all-solid-state rechargeable battery as claimed in claim 5, wherein
the inelastic layer is in contact with both surfaces of the all-solid-state cell.

7. The all-solid-state rechargeable battery as claimed in claim 5, wherein
the inelastic layer surrounds the plurality of piezoelectric elements.

8. The all-solid-state rechargeable battery as claimed in claim 5, wherein
the inelastic layer comprises any one inelastic material selected from inelastic rubber, inelastic clay, plastic, and ceramic.

9. The all-solid-state rechargeable battery as claimed in claim 5, wherein
the inelastic layer further comprises any one insulating material selected from glass, ceramic, plastic, urea foam, foam rubber insulation, and rigid urethane.
